(19) United States
(12) Patent Application Publication
(10) Pub. No.: US 2004/0098746 A1
(43) Pub. Date: May 20, 2004

(54) Method and apparatus for displaying digital broadcasting

(76) Inventors: Chang Sup Lee, Seoul (KR); Jae Bunm Lee, Seoul (KR)

Correspondence Address: BIRCH STEWART KOLASCH & BIRCH, PO BOX 747, FALLS CHURCH, VA, 22040-0747, US

(21) Appl. No.: 10/667,662

(22) Filed: Sep. 23, 2003

(30) Foreign Application Priority Data
Nov. 19, 2002 (KR) 10-2002-0071871

(51) Int. Cl. H04N 7/18

(52) U.S. Cl. 725/80

(57) ABSTRACT

There is provided a method and apparatus for displaying a digital broadcasting, capable of satisfying the audience's right of choice. The apparatus of the present invention includes a signal mixer for selectively mixing AV broadcast signal and data broadcast signal separated from a received broadcast signal in response to a display setup request, and a plurality of display units for displaying the mixed signals. An audience can simultaneously watch AV broadcast signals and data broadcast signals of one or more channels in real time. For this, the apparatus can include one or more means for receiving AV broadcast signals and data broadcast signals of one or more channels. Accordingly, the audiences can watch their favorite broadcastings on one display unit among a plurality of display units without regard to other audiences.

### BACKGROUND OF THE INVENTION

1. Field of the Invention

The present invention relates to a digital television, and more particularly, to a method and apparatus for displaying a digital broadcasting, in which AV broadcast signal and data broadcast signal are provided to different display units.

2. Description of the Related Art

Compared with an analog broadcasting according to the related art, a digital broadcasting provides higher quality audio/video and also provides various and convenient functions including data broadcasting, interactive communication, and the like.

Now, the United States determines to employ a digital system in a next generation television called an advanced television (ATV). In Europe, many projects such as HD DIVINE of Sweden broadcasting, SPECTRE of England and DIAMOND of France broadcasting are in progress.

The digital television is a next generation television system interfacing with B-ISDN or computer networks. Also, researches on the digital television are made actively.

A transport stream transmitted in the digital broadcasting can include audio/video broadcast signal (hereinafter, referred to as AV broadcast signal) and data broadcast signal. Here, the data broadcast signal can be made based on markup such as XDML of hypertext markup language (HTML) and digital TV application software environment (DASE) of advanced television enhancement forum (ATVEF) or based on Java such as Xlet of DASE.

The digital television displays the AV broadcast signal and the data broadcasting data on screen in a manner of picture in picture (PIP), picture out of picture (POP), dual display, etc.

In other words, according to the modes set by an audience, the AV broadcast signal alone may be displayed, or both of the AV broadcast signal and the data broadcast signal may be simultaneously displayed on one screen.

However, in the above-described digital broadcasting, both the AV broadcast signal and the data broadcast signal should be displayed on one screen, thus incurring many problems.

As shown in FIG. 1, a digital television screen can be configured with an AV broadcast screen 10 occupying a relative small area and a data broadcast screen 10 occupying a relative large area. At this time, the AV broadcast signal and the data broadcast signal are displayed on the AV broadcast screen 10 and the data broadcast screen 20, respectively. As a result, the audience has difficulty in viewing the AV broadcast signal since the AV broadcast screen 10 occupies a relatively small area. Particularly, it is troublesome to an audience who has bad sight because the audience should approach the digital television more closely in order to view the AV broadcast signal.

Meanwhile, in case several audiences intend to watch one digital television, each favorite broadcasting channel may be different. In other words, some would like to watch a movie channel and others would like to watch a sport channel.

In this case, it is practically impossible for every audience to simultaneously watch their favorite channels over the digital television having one screen.

Further, the audiences want to watch the broadcast channels without regard to place. For example, some may want to watch broadcast channels through computers, or some may want to watch them through their own terminals at corridors or kitchens. In this case, the conventional digital television is insufficient to meet the audience's demands.

### SUMMARY OF THE INVENTION

Accordingly, the present invention is directed to a method and apparatus for displaying a digital broadcasting that substantially obviates one or more problems due to limitations and disadvantages of the related art.

It is an object of the present invention to provide a method and apparatus for displaying a digital broadcasting, in which AV broadcast signal and data broadcast signal are simultaneously displayed on different display units.

It is another object of the present invention to provide a method and apparatus for displaying a digital broadcasting, in which AV broadcast signals of different broadcast channels are displayed on different display units so that the respective audiences can simultaneously watch their favorite broadcast channels.

It is further another object of the present invention to provide a method and apparatus for displaying a digital broadcasting, in which the respective audiences can watch their favorite broadcastings on screens by mixing AV broadcast signals and data broadcast signals of different broadcast channels.

Additionally advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to a first embodiment of the present invention, a method for displaying a digital broadcasting includes the steps of: separating AV broadcast signal and data broadcast signal from a broadcast signal of one channel; providing the AV broadcast signal to a first display unit; and providing the data broadcast signal to a second display unit.

According to a second embodiment of the present invention, a method for displaying a digital broadcasting includes the steps of: separating AV broadcast signal and data broadcast signal from a broadcast signal of one channel; selectively mixing the AV broadcasting signal and the data broadcast signal according to a display setup request inputted by an audience; and providing the mixed signals to at least one display unit.

The display setup request includes the kinds of display units and screen configurations of display units.

According to a third embodiment of the present invention, a method for displaying a digital broadcasting includes the steps of: separating AV broadcast signal and data broadcast signal from a broadcast signal of one channel in response to a display setup request inputted by an audience; selectively mixing the AV broadcasting signal and the data broadcast signal according to the display setup request; and providing the mixed signals to at least one display unit.

According to a fourth embodiment of the present invention, an apparatus for displaying a digital broadcasting comprises: a processing means for separating AV broadcast signal and data broadcast signal from a broadcast signal of one channel; an input means for inputting a display setup request; and at least one display means for displaying the mixed signals provided from the mixing means.

The processing means include at least one tuning means for receiving and tuning the broadcast signal of one channel, and a separating means for separating the AV broadcast signal and the data broadcast signal from the tuned broadcast signal.

According to a fifth embodiment of the present invention, a method for displaying a digital broadcasting includes the steps of: separating AV broadcast signals and data broadcast signals from broadcast signals of at least one channel; selectively mixing the AV broadcasting signals and the data broadcast signals according to a display setup request inputted by an audience; and providing the mixed signals to at least one display unit.

The broadcast signals of at least one channel are received by corresponding tuners.

According to a sixth embodiment of the present invention, a method for displaying a digital broadcasting includes the steps of: separating AV broadcast signals and data broadcast signals from broadcast signals of at least one channel in response to a display setup request inputted by an audience; selectively mixing the AV broadcasting signals and the data broadcast signals according to the display setup request; and providing the mixed signals to at least one display unit.

According to a seventh embodiment of the present invention, an apparatus for displaying a digital broadcasting comprises: a processing means for separating AV broadcast signals and data broadcast signals from broadcast signals of at least one channel; an input means for inputting a display setup request; a mixing means for selectively mixing the AV broadcast signals and the data broadcast signals according to the display setup request; and a display means for displaying the mixed signals provided from the mixing means.

The processing means include at least one tuning means for receiving and tuning the broadcast signals of at least one channel, and a separating means for separating the AV broadcast signals and the data broadcast signals from the tuned broadcast signals.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment(s) of the present invention and together with the description serve to explain the principle of the present invention. In the drawings:

FIG. 1 is an exemplary view of a conventional digital television screen on which AV data broadcast signal and data broadcast signal are simultaneously displayed;

FIG. 2 is a schematic view illustrating a structure of an apparatus for displaying a digital broadcasting according to a preferred embodiment of the present invention;

FIG. 3 is a flowchart illustrating a method for displaying a broadcast signal of one channel on a plurality of display units according to a preferred embodiment of the present invention;

FIG. 4 is a schematic view illustrating a structure of an apparatus for displaying a digital broadcasting according to another preferred embodiment of the present invention;

FIG. 5 is a flowchart illustrating a method for displaying broadcast signals of at least one channel on a plurality of display units according to another preferred embodiment of the present invention;

FIGS. 6A to 6C are exemplary views of screens on which broadcast signals are displayed in the apparatus for displaying the digital broadcasting according to a preferred embodiment of the present invention; and

FIGS. 7A to 7C are exemplary views of screens on which broadcast signals are displayed in the apparatus for displaying the digital broadcasting according to another preferred embodiment of the present invention.

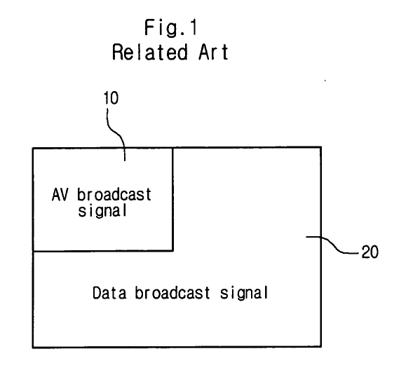

### DETAILED DESCRIPTION OF THE PREFERRED EMBODIMENTS

Reference will now be made in detail to a preferred embodiment of the present invention with reference to the attached drawings.

In recent years, with an advance of communication technologies, home network has been gradually realized. The home network can control at home A/V equipments such as a TV, a DVD, a VCR, etc., and household equipments such as an electronic rice kettle, a refrigerant, a washing machine, etc., as well as information communication equipments such as a personal computer, a fax, a printer, etc., by connecting them via a network.

According to the present invention, other display units including a digital television are connected to the home network via wire or wireless communication, thus displaying desired broadcast signals on respective display units.

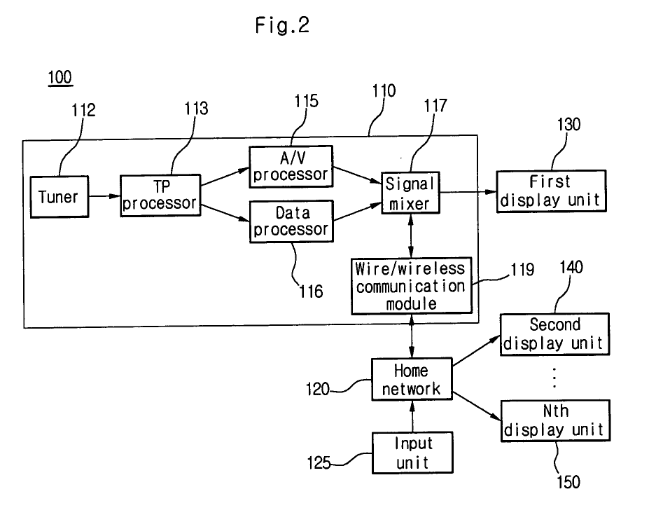

FIG. 2 is a schematic view illustrating a structure of an apparatus for displaying a digital broadcasting according to a preferred embodiment of the present invention.

Referring to FIG. 2, the apparatus 100 according to the present invention includes: a receiver 110 for separating AV broadcast signal and data broadcast signal from a broadcast signal of one channel and providing the AV broadcast signal and the data broadcast signal according to a display setup request inputted by the audience; a home network 120 connected to the receiver 110 via a wire/wireless communication; an input unit 125 connected to the home network 120 via a wire/wireless communication to input the display setup request; and a plurality of display units 130, 140 and 150 connected to the home network 120 via a wire/wireless communication to display the AV broadcast signal and the data broadcast signal provided from the receiver 110.

In more detail, the receiver 110 includes a tuner 112 for tuning the broadcast signals, a TP processor 113 for separating the AV broadcast signal and the data broadcast signal from the tuned broadcast signals provided from the tuner 112, an A/V processor 115 for processing the AV broadcast signal to restore an original AV broadcast signal, a data processor 116 for processing the data broadcast signal to restore an original data broadcast signal, and a signal mixer 117 for selectively mixing the restored AV broadcast signal and the restored data broadcast signal according to the display setup request. At this time, the signals selectively mixed by the signal mixer 117 are provided to the respective display units 130, 140 and 150.

Here, the phrase “selectively mixing” means mixing the signals to be provided to the respective display units 130, 140 and 150 according to the display setup request.

The display setup request inputted by the audience may include the kinds of display units, screen configurations of display units, etc.

For example, the audience can request the first display unit 130 to display the AV broadcast signal, the second display unit 140 the data broadcast signal, and the Nth display unit 150 both the AV broadcast signal and the data broadcast signal, respectively.

Accordingly, in response to the display setup request, the signal mixer 117 provides the AV broadcast signal to the first display unit 130, the data broadcast signal to the second display unit 140, and both the AV broadcast signal and the data broadcast signal to the Nth display unit 150, respectively.

As a result, the audience can watch the broadcastings on a plurality of display units 130, 140 and 150, each of which has different screen configurations.

The receiver 110 further includes a wire/wireless communication module 119 for enabling a communication for the display setup request.

The a plurality of display units 130, 140 and 150 are provided with the first display unit, the second display unit, . . . , and the Nth display unit.

Here, the first display unit 130 is a means that is connected with the signal mixer 117 and displays the mixed signals provided from the signal mixer 117. Preferably, the first display unit 130 can be a television display device. Such a television display device includes an LCD, a PDP, a FED, etc.

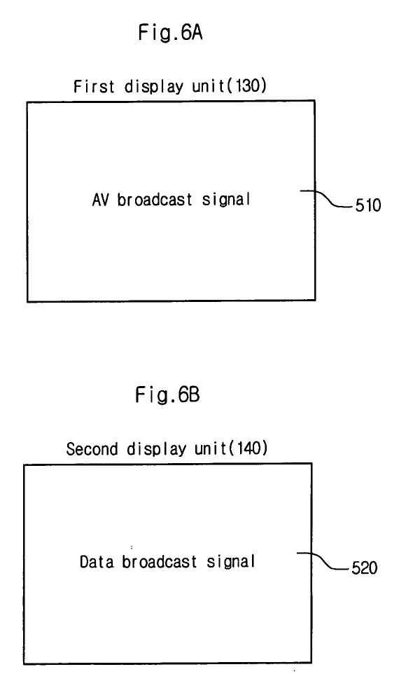

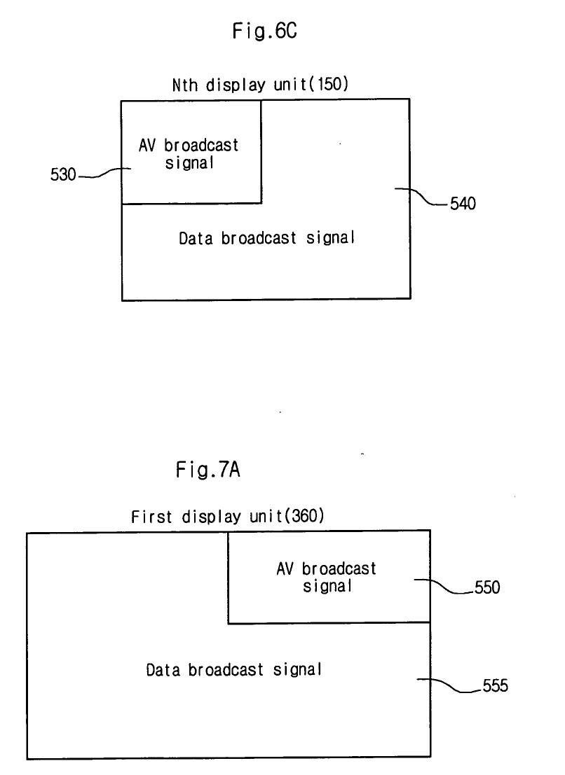

Additionally, as shown in FIG. 6A, the AV broadcast signal 510 is displayed on the first display unit 130. Of course, the data broadcast signal alone or both the AV broadcast signal and the data broadcast signal can be displayed on the first display unit 130.

The second display unit 140 is a means that is connected with the home network 120 and displays the mixed signals provided from the signal mixer 117. Preferably, the second display unit 140 can be a monitor display device. Such a monitor display device includes a CRT, an LCD, a PDP, a touch screen, etc. Of course, the second display unit 140 can be a display device installed in a refrigerator, a washing machine, etc. In other words, any display device connected to the home network 120 to display the mixed signals can be used as the second display unit 140.

Preferably, as shown in FIG. 6B, the data broadcast signal 520 is displayed on the second display unit 140. Of course, the data broadcast signal alone or both the AV broadcast signal and the data broadcast signal can be displayed on the second display unit 140.

The Nth display unit 150 is a means that is connected with the home network 120 and displays the mixed signals provided from the signal mixer 117. Preferably, the Nth display unit 150 can be a terminal display device. Here, the terminal includes any mobile communication device such as portable telephone and PDA.

Preferably, as shown in FIG. 6C, the AV broadcast signal 350 and the data broadcast signal 540 can be simultaneously displayed on the Nth display unit 150.

The input unit 125 is a means for inputting the display setup request and can be any one of a remote controller, a keyboard, a mouse, a keypad and a touch pad.

At this time, the remote controller can directly transfer a command through the wire/wireless communication module 119 without being connected to the home network.

The keypad is separately installed in the terminal if the terminal display device such as the Nth display unit 150 is connected to the home network 120. Such a keypad is generally mounted on the terminal.

The touch pad is an input means that makes it possible to execute a predetermined operation if touching a button displayed on a screen. Like the second display unit 140, the touch pad can be directly mounted on the monitor display device.

For the sake of convenience, the input unit 125 is drawn separately from each display unit 130, 140 and 150 in FIG. 2. However, like the terminal or the monitor display device with built-in touch pad, the input unit and the display unit can be manufactured as one body.

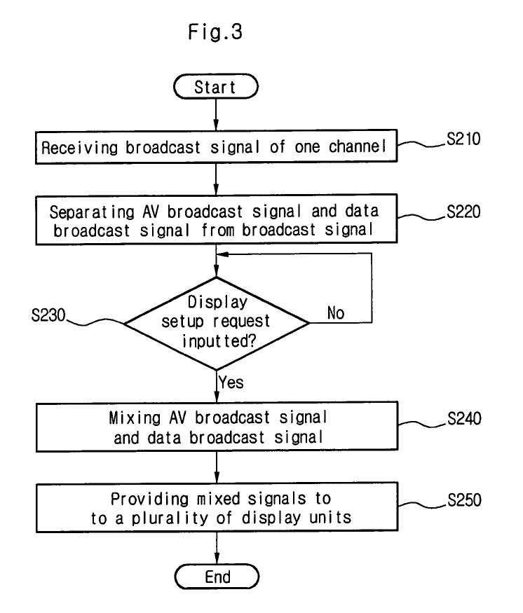

An operation of the apparatus for the displaying the digital broadcasting will be described below with reference to FIG. 3.

FIG. 3 is a flowchart illustrating a method for displaying the broadcast signal of one channel on a plurality of display units according to a preferred embodiment of the present invention.

Referring to FIG. 3, first, the tuner 112 receives and tunes the broadcast signal of one channel (S210).

The TP processor 113 separates the AV broadcast signal and the data broadcast signal from the tuned broadcast signal, and the AV broadcast signal and the data broadcast signal are provided to the AV processor 115 and the data processor 116, respectively (S220). In other words, the AV broadcast signal is provided to the AV processor 115 and the data broadcast signal is provided to the data processor 116.

Thereafter, the AV processor 115 restores the original AV broadcast signal from the AV broadcast signal, and the data processor 116 restores the original data broadcast signal from the data broadcast signal.

The restored AV broadcast signal and the restored data broadcast signal are provided to the signal mixer 117.

At this time, the signal mixer 117 checks whether the display setup request is inputted or not (S230). The display setup request, as described above, includes the kinds of the display units and the screen configurations of the display units.

As the check result, if the display setup request is inputted, the signal mixer 117 selectively mixes the AV broadcast signal and the data broadcast signal received from the AV processor 115 and the data processor 116 according to the display setup request (S240). In other words, the respective signals are selectively mixed according to the screen configurations of the display units.

The mixed signals are provided to the corresponding display units 130, 140 and 150 and displayed thereon (S250).

For example, if the display setup request is to display the AV broadcast signal and the data broadcast signal on the first display unit 130 and the second display unit 140, respectively, the signal mixer 117 mixes the signals responsive to the display setup request. The AV broadcast signal and the data broadcast signal are provided to the first display unit 130 and the second display unit 140 in response to the mixed signals.

At this time, it is preferable that the first display unit 130 has a relatively wider screen than the second display unit 140. In other words, it is preferable that the first display unit 130 is the television display unit and the second display unit 140 is the monitor display unit.

Of course, the data broadcast signal can be displayed on the Nth display unit (e.g., the terminal) 150.

Although the step S230 of inputting the display setup request is carried out after separating the AV broadcast signal and the data broadcast signal from the broadcast signal, the step S230 may be carried out prior to the step S210.

In other words, after receiving the display setup request, the step S220 is carried out without regard to the display setup request, and then, the AV broadcast signal and the data broadcast signal are mixed according to the display setup request and provided to the corresponding display units.

According to the method and apparatus of the present invention, the audiences can simultaneously watch their favorite broadcastings on the different display units by controlling each display unit without regard to time and place. Additionally, if some audience would like to watch only the broadcastings of the AV broadcast signal and others would like to watch only the broadcasting of the data broadcast signal, the respective audiences can watch their desired broadcastings on the different display units.

Meanwhile, if a plurality of tuners are provided to the receiver 110, the broadcast signals of each channel (including AV broadcast signals and data broadcast signals) can be simultaneously displayed on the different display units.

A following description will be made on the method and apparatus for displaying the broadcast signals of the different channels on the different display units by using a plurality of tuners.

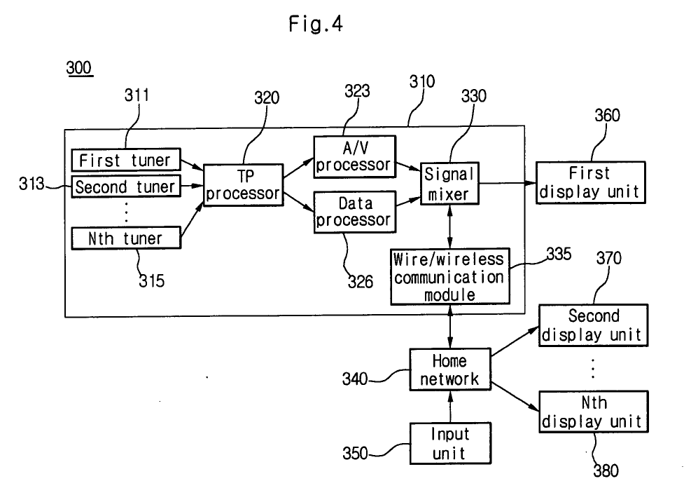

FIG. 4 is a schematic view of an apparatus for displaying a digital broadcasting according to another preferred embodiment of the present invention.

Referring to FIG. 4, the apparatus 300 according to another preferred embodiment of the present invention includes: a receiver 310 for separating AV broadcast signals and data broadcast signals from broadcast signals of a plurality of channels and providing the AV broadcast signals and the data broadcast signals according to a display setup request inputted by the audience; a home network 340 connected to the receiver 310 via a wire/wireless communication; an input unit 350 connected to the home network 340 via a wire/wireless communication to input the display setup request; and a plurality of display units 360, 370 and 380 connected to the home network 340 via a wire/wireless communication to display the AV broadcast signals and the data broadcast signals provided from the receiver 310.

The receiver 310 includes a plurality of tuners 311, 313 and 315 for tuning the broadcast signals of a plurality of channels, a TP processor 320 for separating the AV broadcast signals and the data broadcast signals from the tuned broadcast signals, an A/V processor 323 for processing the AV broadcast signals to restore original AV broadcast signals, a data processor 326 for processing the data broadcast signals to restore original data broadcast signals, and a signal mixer 330 for selectively mixing the restored AV broadcast signals and the restored data broadcast signals according to the display setup request. At this time, the signals selectively mixed by the signal mixer 330 are provided to the respective display units 360, 370 and 380.

Here, the phrase “selectively mixing” means mixing the signals to be provided to the respective display units according to the display setup request.

The display setup request may include the kinds of the display units, screen configurations of the display units, etc.

The signal mixer 330 selectively mixes the AV broadcast signals and the data broadcast signals, which are inputted from the A/V processor 323 and the data processor 326, according to the display setup request and provides the mixed signals to the corresponding display units 360, 370 and 380.

For example, the signal mixer 330 can provide the AV broadcast signals of a plurality of channels to the first display unit 360 according to the display setup request.

The signal mixer 330 can provide both the AV broadcast signal and the data broadcast signal of one channel to the first display unit 360 according to the display setup request.

The signal mixer 330 can provide both the AV broadcast signals and the data broadcast signals of a plurality of channels to the first display unit 360 according to the display setup request.

Of course, the signal mixer 330 can provide various broadcast signals to the other display units 370 and 380 as well as the first display unit 360 according to the display setup request.

According to the present invention, the broadcast signals of the channels can be simultaneously received and tuned through the a plurality of tuners 311, 313 and 315, and the AV broadcast signals and the data broadcast signals separated from the tuned broadcast signals can be selectively mixed according to the display setup request and provided to the display units 360, 370 and 380.

Therefore, the audiences can watch the AV broadcast signal of one channel, the AV broadcast signal and the data signal of one channel, the AV broadcast signals of a plurality of channels, and the AV broadcast signals and the data broadcast signals of a plurality of channels on the display units selected by the audiences.

Specifically, the AV broadcast signals of a plurality of channels can be displayed on one screen. Since the audiences can select a specific AV broadcast signal among the AV broadcast signals of one or mere channels which are being simultaneously displayed, the audiences can select and watch the AV broadcast signals of their favorite channels at any time.

Meanwhile, the receiver 310 further includes a wire/wireless communication module 335 for enabling a communication for the display setup request.

The a plurality of display units 360, 370 and 380 are provided with the first display unit, the second display unit, . . . , and the Nth display unit.

Here, the first display unit 360 is a means that is connected with the signal mixer 330 and displays the mixed signals provided from the signal mixer 330. Preferably, the first display unit 360 can be a television display device. Such a television display device includes an LCD, a PDP, a FED, etc.

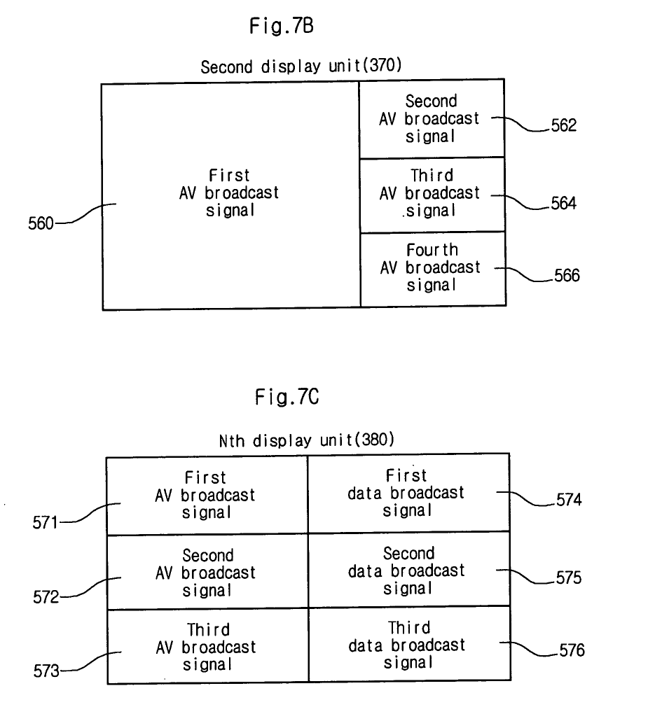

As shown in FIG. 7A, both the AV broadcast signal 550 and the data broadcast signal of one channel are displayed on the first display unit 360. Also, the AV broadcast signal of one channel and the data broadcast signals of other channels can be displayed on the first display unit 360.

The second display unit 370 is a means that is connected with the home network 340 and displays the mixed signals provided from the signal mixer 330. Preferably, the second display unit 370 can be a monitor display device. Such a monitor display device includes a CRT, an LCD, a PDP, a touch screen, etc. Of course, the second display unit 370 can be a display device installed in a refrigerator, a washing machine, etc. In other words, any display device connected to the home network 340 to display the mixed signals can be used as the second display unit 370.

Preferably, as shown in FIG. 7B, the AV broadcast signals 560, 562, 564 and 566 of a plurality of channels can be simultaneously displayed on the second display unit 140.

The Nth display unit 380 is a means that is connected with the home network 330 and displays the mixed signals provided from the signal mixer 330. Preferably, the Nth display unit 380 can be a terminal display device. Here, the terminal can be any mobile communication device such as portable telephone and PDA.

Preferably, as shown in FIG. 7C, the AV broadcast signals 571, 572 and 573 and the data broadcast signals 574, 575 and 576 of a plurality of channels are simultaneously displayed on the Nth display unit 380.

The input unit 350 is a means for inputting the display setup request and can be a remote controller, a keyboard, a mouse, a keypad, or a touch pad.

At this time, the remote controller can directly transfer a command through the wire/wireless communication module 335 without being connected to the home network 340.

The keypad is separately installed in the terminal if the terminal display device such as the Nth display unit 380 is connected to the home network 340. Such a keypad is generally mounted on the terminal.

The touch pad is an input means which makes it possible to execute a predetermined operation if touching a button displayed on a screen. Like the second display unit 370, the touch pad can be directly mounted on the monitor display device.

For the sake of convenience, the input unit 350 is drawn separately from the display units 360, 370 and 380 in FIG. 4. However, like the terminal or the monitor display device with built-in touch pad, the input unit and the display unit can be manufactured as one body.

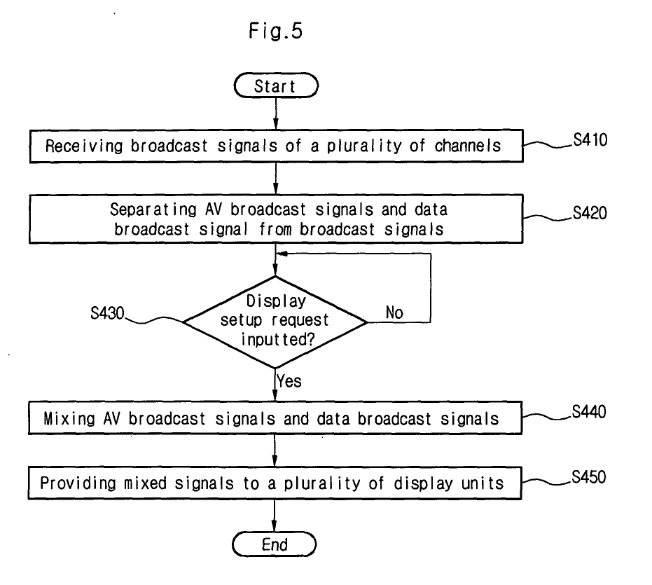

An operation of the apparatus for the displaying the digital broadcasting will be described below with reference to FIG. 5.

FIG. 5 is a flowchart illustrating a method for displaying the broadcast signals of a plurality of channels on a plurality of display units according to another preferred embodiment of the present invention.

Referring to FIG. 5, first, the tuners 311, 313 and 315 receive and tune the corresponding broadcast signals of a plurality of channels (S410).

The TP processor 320 separates the AV broadcast signals and the data broadcast signals from the tuned broadcast signals, and the AV broadcast signals and the data broadcast signals are provided to the AV processor 323 and the data processor 326, respectively (S420). In other words, the AV broadcast signals are provided to the AV processor 323 and the data broadcast signals are provided to the data processor 326.

Thereafter, the AV processor 323 restores the original AV broadcast signals from the AV broadcast signals, and the data processor 326 restores the original data broadcast signals from the data broadcast signals.

The restored AV broadcast signals and the restored data broadcast signals are provided to the signal mixer 330.

At this time, the signal mixer 330 checks whether the display setup request is inputted or not (S430). The display setup request, as described above, includes the kinds of the display units and the screen configurations of the display units.

As the check result, if the display setup request is inputted, the signal mixer 330 selectively mixes the AV broadcast signals and the data broadcast signals received from the AV processor 323 and the data processor 326 according to the display setup request (S240). In other words, the respective signals are selectively mixed according to the screen configurations of the display units.

The mixed signals are provided to the corresponding display units 360, 370 and 380 and displayed thereon (S450).

For example, if the display setup request is to display the AV broadcast signals of a plurality of channels on the first display unit 360 and to display both the AV broadcast signals and the data broadcast signals of a plurality of channels on the second display unit 370, the signal mixer 330 mixes the signals responsive to the request. In response to the mixed signals, the AV broadcast signals of a plurality of channels are provided to the first display unit 360, and the AV broadcast signals and the data broadcast signals of a plurality of channels are provided to the second display unit 370.

Although FIG. 5 shows that the step S430 of inputting the display setup request is carried out after separating the AV broadcast signal and the data broadcast signal from the broadcast signal, the step S430 may be carried out prior to the step S410.

In other words, after receiving the display setup request, the step S220 is carried out without regard to the display setup request, and then, the AV broadcast signal and the data broadcast signal are mixed according to the display setup request and provided to the corresponding display units.

According to the method and apparatus of the present invention, the audiences can simultaneously watch their favorite broadcastings on the different display units by controlling each display unit without regard to time and place. Here, the favorite broadcastings may be the AV broadcast signals of one or more channels, or the AV broadcast signals and the data broadcast signals of a plurality of channels. If some would like to watch the AV broadcast signal of a channel and others would like to watch the AV broadcast signal of other channel, the respective audience can watch their desired broadcastings on the different display units.

Additionally, according to the present invention, the broadcast signals of a plurality of channels (including the AV broadcast signals and the data broadcast signals) can be provided to different display units by connecting the receiver to Internet. Further, watching the broadcastings of one or more channels, the audience can simultaneously obtain necessary information through Internet surfing.

According to the present invention, an OSD setup menu stored in the receiver can be provided to the different display units together with the broadcast signals of one or more channels.

Furthermore, watching the broadcastings of one or more channels on one display unit, the audience can reset the digital television using the OSD setup menu.

As described above, in the method and apparatus of the present invention, AV broadcast signal and data broadcast signal of one channel are displayed on different display units according to the display setup request. Therefore, the audiences can comfortably watch the broadcasting programs without regard to other audiences because their favorite broadcastings are displayed on different display units.

Further, in the method and apparatus of the present invention, AV broadcast signals and data broadcast signals of one or more channels are displayed on different display units according to the display setup request. Therefore, several audiences can watch AV broadcast signals of their favorite channels on the corresponding display units in real time.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for displaying a digital broadcasting, the method comprising the steps of:
separating AV broadcast signals and data broadcast signals from broadcast signals of at least one channel;
selectively mixing the AV broadcast signals and the data broadcast signals according to a display setup request inputted by an audience; and
providing the mixed signals to at least one display unit;

2. The method according to claim 1, wherein the broadcast signals of the at least one channel are received by corresponding tuners.

3. The method according to claim 1, wherein the display setup request includes the kinds of display units and screen configurations of display units.

4. The method according to claim 1, wherein the AV broadcast signal of one channel is displayed on one display unit among the at least one display unit.

5. The method according to claim 1, wherein the AV broadcast signal of one channel and the data broadcast signals of other channels are displayed on one display unit among the at least one display unit.

6. The method according to claim 1, wherein the data broadcast signal of one channel is displayed on another display unit among the at least one display unit.

7. The method according to claim 1, wherein the AV broadcast signals of at least one channel are displayed on another display unit among the at least one display unit.

8. The method according to claim 1, wherein the AV broadcast signal and the data broadcast signal of one channel are displayed on further another display unit among the at least one display unit.

9. The method according to claim 1, wherein the AV broadcast signals and the data broadcast signals of at least one channel are displayed on further another display unit among the at least one display unit.

10. The method according to claim 1, wherein the at least one display unit are any one of a television display device, a monitor display device, and a terminal display device.

11. A method for displaying a digital broadcasting, the method comprising the steps of:
separating AV broadcast signals and data broadcast signals from broadcast signals of at least one channel in response to an display setup request inputted by an audience;
selectively mixing the AV broadcast signals and the data broadcast signals according to the display setup request; and
providing the mixed signals to at least one display unit.

12. An apparatus for displaying a digital broadcasting, comprising:
a processing means for separating AV broadcast signals and data broadcast signals from broadcast signals of at least one channel;
an input means for inputting a display setup request;
a mixing means for selectively mixing the AV broadcast signals and the data broadcast signals according to the display setup request inputted from the input means; and
at least one display means for displaying the mixed signals provided from the mixing means.

13. The apparatus according to claim 12, wherein the processing means include:
at least one tuning means for receiving and tuning the broadcast signals of at least one channel; and
a separating means for separating the AV broadcast signals and the data broadcast signals from the tuned broadcast signals.

14. The apparatus according to claim 12, wherein the display setup request includes the kinds of display units and screen configurations of display units.

15. The apparatus according to claim 12, wherein the input means is any one of a remote controller, a keyboard, a mouse, a keypad, and a touch pad.

16. The apparatus according to claim 12, wherein the at least one display means include:
a first display unit for displaying AV broadcast signal of one channel;
a second display unit for displaying data broadcast signal of one channel; and
a third display unit for displaying the AV broadcast signal and the data broadcast signal of one channel.

17. The apparatus according to claim 16, wherein the first display unit displays the AV broadcast signal of one channel and the data broadcast signals of other channels.

18. The apparatus according to claim 16, wherein the second display unit displays AV broadcast signals of at least one channel.

19. The apparatus according to claim 16, wherein the third display unit displays AV broadcast signals and data broadcast signals of at least one channel.

20. The apparatus according to claim 12, wherein the at least one display means include any one of a television display device, a monitor display device, and a terminal display device.
